(19) United States
(12) Patent Application Publication
(10) Pub. No.: US 2016/0110958 A1
(43) Pub. Date: Apr. 21, 2016

(54) Electronic Gaming Machine And Gaming Method

(71) Applicant: Ainsworth Game Technology Limited, Newington (AU)

(72) Inventor: Jason Meyer, Abbotsford (AU)

(21) Appl. No.: 14/882,418

(22) Filed: Oct. 13, 2015

(30) Foreign Application Priority Data
Oct. 20, 2014 (AU) 2014904186

(51) Int. Cl. G07F 17/32; G07F 17/34

(52) U.S. Cl. CPC G07F 17/3267; G07F 17/34; G07F 17/3288; G07F 17/3258; G07F 17/3211

(57) ABSTRACT

The present invention provides an electronic gaming machine comprising a display for displaying a game, an electronic game controller and a value transfer mechanism. The electronic gaming machine offers a plurality of bonus prize sets, each bonus prize set comprising at least one progressive jackpot prize. Some of the bonus prize sets are available for selection by a player, depending on a designated player selection. Upon making the designated player selection, the available bonus prize sets become selectable by the player. The player selected bonus prize set becomes active for one or more subsequent plays of the game. One or more of the bonus prizes of the selected bonus prize set are awarded to the player upon the occurrence of a bonus prize trigger event in the subsequent plays. The player is able to change the selected bonus prize set in the subsequent plays.

### BACKGROUND

The present invention relates to an electronic gaming machine and in a particular an electronic gaming machine using a base game and a feature game. The invention has been developed primarily for use as an electronic gaming machine and will be described hereinafter by reference to this application.

The following discussion of the prior art is intended to present the invention in an appropriate technical context and allow its advantages to be properly appreciated. Unless clearly indicated to the contrary, however, reference to any prior art in this specification should not be construed as an express or implied admission that such art is widely known or forms part of common general knowledge in the field.

Conventional gaming machines typically involve awarding prizes to a player according to predetermined combinations of game symbols that appear on an array of game squares displayed on a screen, typically organised into three rows and five columns (a 5×3 array). Other arrays, such as a 3×3 or 4×3, may be used. Each gaming machine randomly selects the game symbols that appear on the array, each column of the array being a “reel”.

In an electronic gaming machine, the mechanical reels are replaced with video images of the reels, which are displayed on a video display screen. The electronic gaming machine has an internal electronic game controller, typically a computer, that controls the display of images on the video display screen so that the reels are visibly spun on the screen to simulate a physical reel of a traditional gaming machine. Electronic gaming machines are also more versatile in presenting game information, varying the probabilities for a player to win a prize and varying the type of game that is played.

Bonus or “feature” games may also be provided by an electronic gaming machine in addition to a base or main game. Typically feature games use the same set of reels as the main game and are limited to a set of free games operated under a single set of rules. This means that the feature game is restricted by the same set of rules, and so there is no variation in the play of the feature game.

Also, electronic gaming machines can offer one or more bonus prizes to the player during play of the game. The most common type of bonus prize that is awarded by the electronic gaming machine is a jackpot prize, the main example of which is a progressive jackpot prize.

This standard structure to game play and bonus prizes limits the variation in the play of the electronic gaming machine. Consequently, it is difficult to retain player interest because there is no apparent incentive for the player to continue playing the same electronic gaming machine once the player becomes familiar with the feature game, the main game and any bonus prizes. Also, it is difficult to retain player interest since there is little differentiation between gaming machines in terms of the main and feature games that are played.

This problem is exacerbated when more than one game is offered to play on the same electronic gaming machine. The option to play different games on a single machine is attractive to the player as there is no need to keep switching machines to play a different game. While this introduces some variation in game play due to different games being provided on the electronic gaming machine, the bonus prizes are often the same across the offered games.

It is an object of the present invention to overcome or substantially ameliorate one or more of the disadvantages of prior art, or at least to provide a useful alternative.

### SUMMARY

According to a first aspect of the invention, there is provided an electronic gaming machine comprising:

a display for displaying a game, wherein said game comprises game symbols and predetermined winning combinations of randomly selected game symbols award prizes to a player, and

an electronic game controller for controlling the display of said game symbols on the display,

wherein said electronic game controller causes said electronic gaming machine to offer a plurality of bonus prize sets, each bonus prize set comprising at least one progressive jackpot prize, and some of said bonus prize sets being available for selection by said player depending on a designated player selection;

said player making said designated player selection, said available bonus prize sets becoming selectable by a player in a play of said game;

said player selects one of said available bonus prize sets, said selected available bonus prize set becoming active for one or more subsequent plays of said game, and one or more of said bonus prizes of said selected bonus prize set are awarded to the player upon the occurrence of a bonus prize trigger event in said one or more subsequent plays; and

said player is able to change said selected bonus prize set in said one or more subsequent plays.

Preferably, said player directly selects at least one bonus prize set that is active during play of said game. Alternatively, said player indirectly selects at least one bonus prize set that is active during play of said game.

Preferably, at least one available bonus prize set cannot be active during said one or more subsequent plays.

Preferably, at least one bonus prize set comprises a mystery jackpot level which is associated with at least one of a start value, increment value and threshold ‘win before’ value,

Preferably, at least one bonus prize set comprises a standalone progressive jackpot.

Preferably, at least one bonus prize set comprises a linked progressive jackpot associated with a linked jackpot controller.

Preferably, at least one bonus prize set comprises a symbol driven jackpot associated with a trigger combination of game symbols appearing in said game.

Preferably, at least one bonus prize set comprises a standalone progressive jackpot and another bonus prize set comprises a linked progressive jackpot associated with a linked jackpot controller.

Preferably, said electronic game controller causes said display to display a selection screen that can be activated at any time between plays of said game, said selection screen enabling said player to select selects one of said available bonus prize sets. More preferably, said selection screen provides a plurality of bonus prize set configuration options selectable by said player. In one embodiment, said electronic game controller causes said display to show a menu screen image associated with said selection screen, wherein said menu screen image is selectable by said player for accessing said selection screen to enable said player selection of one of said available bonus prize sets.

Preferably, said selection screen enables said player to select the bet denomination for said game. More preferably, said selection screen displays two or more denomination images associated with two or more of said games, wherein said denomination images are selectable by a player for selecting the bet denomination. In one embodiment, any jackpot level can be multiplied by a factor associated with the bet denomination selected by said player.

Preferably, said selection screen enables said player to select the number of lines for said game. More preferably, said selection screen displays two or more line images associated with said game, wherein said line images are selectable by a player for selecting the number of lines to play in said game.

Preferably, there is a plurality of games on said electronic gaming machines, and said selection screen enables said player to select one or more of said games to play on said electronic gaming machine. More preferably, said selection screen displays two or more game images respectively associated with two or more of said games, wherein said game images are selectable by a player for selecting one of said games.

Preferably, said electronic game controller causes said electronic gaming machine to display two or more game images respectively associated with two or more of said games, wherein said game images are selectable by a player for selecting one of said games; said electronic game controller causes said electronic gaming machine to display two or more denomination images associated with two or more of said games, wherein said denomination images are selectable by a player for selecting the bet denomination in which said selected game is to be played, and wherein one of said game images and said denomination images is initially displayed on said display for selection by said player and is replaced by the other of said game images and said denomination images on said display after said player makes a selection of said one of said game images and said denomination images. More preferably, said electronic game controller causes said electronic gaming machine to display two or more line images associated with said selected game, wherein said line images are selectable by a player for selecting the number of lines to play in said selected game.

Preferably, said game images are initially displayed on said display.

Preferably, said denomination images are initially displayed on said display.

Preferably, one or more of said denomination images are the same for at least two of said selectable games. More preferably, wherein one or more of said denomination images are different for at least two of said selectable games.

Preferably, said electronic game controller causes said electronic gaming machine to display two or more line images associated with said selected game, wherein said line images are selectable by a player for selecting the number of lines to play in said selected game.

Preferably, one or more of said line images are the same for at least two of said selectable games.

Preferably, in said selected game, said electronic game controller causes the display of said denomination images for said player to select and change the bet denomination of said selected game. More preferably, said electronic game controller causes the display of said denomination images in response to a trigger event. In one preferred form, said trigger event is a player-actuated trigger event. In a particularly preferred form, said player-actuated trigger event comprises selection of a bet denomination image on said display. In a further preferred form, said bet denomination image comprises the denomination image associated with the bet denomination initially selected by said player.

Preferably, a default denomination image is displayed prior to said player selecting one of said denomination images. More preferably, said default denomination image comprises the denomination image that was last selected on said electronic gaming machine.

Preferably, said game images comprise the names of said games associated with said game images. More preferably said game images comprise one or more pictorial images associated with said games.

Preferably, said denomination images comprise numerical values corresponding to the monetary values of said bet denominations associated with said selected game.

Preferably, when said selected available bonus prize set becomes active, only the bonus prizes in said selected available jackpot set are contributed to by the electronic game controller.

Preferably, said player can select all of said available bonus prize sets to be active for said one or more subsequent plays.

Preferably, said player can select only one of said available bonus prize sets to be active for said one or more subsequent plays.

Preferably, any jackpot level can be changed in association with any player selection.

Preferably, the electronic gaming machine further comprises input means for receiving said player selection and said designated player selection, wherein said input means comprises one or more buttons in electronic communication with said electronic game controller to transmit said player selection and said designated player selection to said electronic game controller.

Alternatively or additionally, the electronic gaming machine comprises input means for receiving said player selection and said designated player selection, wherein said input means comprises a touch sensitive surface on said display for receiving said player selection and said designated player selection, said touch sensitive surface being in electronic communication with said electronic game controller to transmit said player selection and said designated player selection to said electronic game controller.

Preferably, said electronic game controller causes said electronic gaming machine to offer one or more player versus player type game and enabling said player to select one or more of said player versus player type games, and wherein said player versus player type game comprises the award of an additional bonus prize in addition to said bonus prizes in said selected available bonus prize set. More preferably, said selected player versus player type game comprises a game played with another player at the same time as said game. Alternatively, said selected player versus player type game comprises a game played with another player at a different time to said game.

Preferably, said games share one of said bonus prizes in said selected available bonus prize set. More preferably, said games share all the bonus prizes in said selected available bonus prize set. In one embodiment, said games share said plurality of bonus prize sets.

Preferably, said game or games comprise a base game and a feature game. More preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to a trigger event in said base game. Alternatively, said electronic game controller causes the display of said feature game and said base game during play of said base game, said feature game being inactive until triggered. In this embodiment, the change in said feature game from being inactive to active may be indicated on the display.

Preferably, said game comprises said game symbols arranged in a plurality of symbol or game positions in an array. More preferably, said array comprises one or more rows and/or columns of said symbol positions. In one embodiment, said array comprises a plurality of reels.

Preferably, the player selectively starts and/or stops play of said reels in said game array and/or said reels in said feature game.

Preferably, said electronic gaming machine comprises input means for receiving said player selection and said designated player selection, wherein said input means comprises one or more buttons in electronic communication with said electronic game controller to transmit said player selection and said designated player selection to said electronic game controller.

Preferably, said electronic gaming machine comprises input means for receiving said player selection and said designated player selection, wherein said input means comprises a touch sensitive surface on said display for receiving said player selection and said designated player selection, said touch sensitive surface being in electronic communication with said electronic game controller to transmit said player selection and said designated player selection to said electronic game controller.

Preferably, said input means comprises one or more buttons on said housing, said buttons being in electronic communication with said electronic game controller to transmit player commands to said electronic game controller. More preferably, said buttons are arranged on a console of said housing. Alternatively or additionally, said input means comprises a touch sensitive surface on said display for receiving player commands, said touch sensitive surface being in electronic communication with said electronic game controller to transmit player commands to said electronic game controller.

Preferably, said housing comprises a value transfer mechanism for paying said prizes to said player using value in an amount equal to an awarded prize. More preferably, said value transfer mechanism also receives value from said player to initiate said bet. In one embodiment, said value transfer mechanism comprises one or more vending slots for paying and/or receiving value. In other embodiments, said value transfer mechanism comprises a value input/value output device. In further embodiments, said value transfer mechanism comprises a coin slot or acceptor, a paper currency acceptor, a ticket reader and/or printer or a card reader and/or writer.

Throughout the specification and unless explicitly stated otherwise, the term “value” means credits, gaming tokens, coins, paper, currency, tickets, vouchers, credit cards, debit cards, smart cards, memory devices capable of storing value and any other object representative of value.

Preferably, said game symbols in said feature game and said base game are arranged in arrays of the same shape or type. Alternatively, said game symbols in said feature game and said base game are arranged in differently shaped arrays. The shapes of said arrays are preferably rectangular, circular, triangular, oval, semi-circular or other non-rectangular shape.

Preferably, said electronic game controller causes the display of said feature game in response to said trigger event. Alternatively, said electronic game controller causes the display of said feature game and said base game during play of said base game, said feature game being inactive until triggered. In this preferred form, the change in said feature game from being inactive to active may be indicated on the display.

Preferably, the electronic gaming machine comprises a mobile electronic gaming device. More preferably, said mobile electronic gaming device comprises a handheld electronic device. Alternatively, said electronic gaming machine comprises a computer. More preferably, said computer is connected to a communication network.

A second aspect of the present invention provides an electronic gaming machine comprising:

a housing having a display for displaying game symbols for playing a game and an electronic game controller in electronic communication with said display for controlling the appearance of game symbols in said game on the display;

wherein said game comprises randomly displaying said game symbols and awarding prizes to a player for predetermined winning combinations of game symbols to a player; and

an input means for receiving commands from said player to operate said electronic gaming machine and initiate play of said game on said display, said input means being in electronic communication with said electronic game controller;

wherein said electronic game controller in response to a command from said player via said input means commences play of said game by randomly selecting game symbols and transmitting a signal to said display to display said randomly selected game symbols;

said electronic game controller causes said electronic gaming machine to offer a plurality of bonus prize sets, each bonus prize set comprising at least one progressive jackpot prize, and some of said bonus prize sets are available for selection by said player via said input means depending on a designated player selection;

in response to said player making said designated player selection via said input means, said electronic game controller transmits a signal to said display to show said available bonus prize sets for selection by said player in a play of said game;

in response to said player selecting one of said available bonus prize sets via said input means, said electronic game controller causes said selected available bonus prize set to become active for one or more subsequent plays of said game, and one or more of said bonus prizes of said selected bonus prize set are awarded to said player upon the occurrence of a bonus prize trigger event in said one or more subsequent plays; and

said player is able to change said selected bonus prize set via said input means in said one or more subsequent plays.

This second aspect of the invention preferably has the preferred features of the first aspect of the invention stated above, where applicable.

According to a third aspect of the invention, there is provided a gaming method for an electronic gaming machine comprising a display and an electronic game controller, the method comprising the steps of:

controllably displaying game symbols for playing a game, wherein said game comprises game symbols and predetermined winning combinations of randomly selected game symbols award prizes to a player;

offering a plurality of bonus prize sets, each bonus prize set comprising at least one progressive jackpot prize, some of said bonus prize sets being available for selection by said player depending on a designated player selection;

in response to said player making said designated player selection, making said available bonus prize sets selectable by said player in a play of said game;

in response to said player selecting one of said available bonus prize sets, making said selected available bonus prize set active for one or more subsequent plays of said game, and one or more of said bonus prizes of said selected bonus prize set are awarded to said player upon the occurrence of a bonus prize trigger event in said one or more subsequent plays; and

making said selected bonus prize set changeable by said player to another available bonus prize set in said one or more subsequent plays.

Preferably, said method comprises directly selecting at least one bonus prize set that is active during play of said game. Alternatively, said method comprises indirectly selecting at least one bonus prize set that is active during play of said game.

Preferably, said method comprises making at least one available bonus prize set unable to be active during said one or more subsequent plays.

Preferably, said method comprises providing at least one bonus prize set that comprises a mystery jackpot level which is associated with at least one of a start value, increment value and threshold ‘win before’ value,

Preferably, said method comprises providing at least one bonus prize set that comprises a standalone progressive jackpot.

Preferably, said method comprises providing at least one bonus prize set that comprises a linked progressive jackpot associated with a linked jackpot controller.

Preferably, said method comprises providing at least one bonus prize set that comprises a symbol driven jackpot associated with a trigger combination of game symbols appearing in said game.

Preferably, said method comprises providing at least one bonus prize set that comprises a standalone progressive jackpot and another bonus prize set comprises a linked progressive jackpot associated with a linked jackpot controller.

Preferably, said method comprises displaying a selection screen that can be activated at any time between plays of said game and enabling said player to select one of said available bonus prize sets via said selection screen. More preferably, said method comprises providing a plurality of bonus prize set configuration options selectable by said player. In one embodiment, said method comprises displaying a menu screen image associated with said selection screen, wherein said menu screen image is selectable by said player for accessing said selection screen to enable said player selection of one of said available bonus prize sets.

Preferably, said method comprises enabling said player to select the bet denomination for said game via said selection screen. More preferably, said method comprises displaying two or more denomination images associated with two or more of said games on said selection screen, wherein said denomination images are selectable by a player for selecting the bet denomination. In one embodiment, said method comprises multiplying any jackpot level by a factor associated with the bet denomination selected by said player.

Preferably, said method comprises enabling said player to select the bet denomination the number of lines for said game via said selection screen. More preferably, said method comprises displaying two or more line images associated with said game on said selection screen, wherein said line images are selectable by a player for selecting the number of lines to play in said game.

Preferably, said method comprises providing a plurality of games on said electronic gaming machines, and enabling said player to select one or more of said games to play on said electronic gaming machine via said selection screen. More preferably, said method comprises displaying two or more game images respectively associated with two or more of said games on said selection screen, wherein said game images are selectable by a player for selecting one of said games.

Preferably, said method comprises displaying two or more game images respectively associated with two or more of said games, wherein said game images are selectable by a player for selecting one of said games; displaying two or more denomination images associated with two or more of said games, wherein said denomination images are selectable by a player for selecting the bet denomination in which said selected game is to be played; and initially displaying one of said game images and said denomination images on said display for selection by said player and replacing said one of said game images and said denomination images by the other of said game images and said denomination images on said display after said player makes a selection of said one of said game images and said denomination images. More preferably, said method comprises displaying two or more line images associated with said selected game, wherein said line images are selectable by a player for selecting the number of lines to play in said selected game.

Preferably, said method comprises making said electronic game controller contribute to only the bonus prizes in said selected available jackpot set in response to said selected available bonus prize set becoming active.

Preferably, said method comprises making all of said available bonus prize sets selectable by said player to be active for said one or more subsequent plays.

Preferably, said method comprises making only one of said available bonus prize sets to be active for said one or more subsequent plays.

Preferably, said method comprises making any jackpot level changeable in association with any player selection.

Preferably, said method comprises offering one or more player versus player type games to said player and enabling said player to select one or more of said player versus player type games, wherein said player versus player type games comprise the award of an additional bonus prize in addition to said bonus prizes in said selected available bonus prize set. More preferably, said selected player versus player type game comprises a game played with another player at the same time as said game. Alternatively, said selected player versus player type game comprises a game played with another player at a different time to said game.

Preferably, said initially displaying step comprises initially displaying said game images on said display.

Preferably, said initially displaying step comprises initially displaying said denomination images on said display.

Preferably, said method further comprises the step of providing one or more of said denomination images to be the same for at least two of said selectable games.

Preferably, said method further comprises the step of displaying two or more line images associated with said selected game, wherein said line images are selectable by a player for selecting the number of lines to be played in said selected game. More preferably, said line images each comprise a numerical value representing the number of lines to be played in said selected game. In one preferred form, said step of displaying two or more line images comprises providing one or more of said line images to be the same for at least two of said selectable games.

Preferably, said method further comprises the step of displaying said denomination images in said selected game for said player to select and change the bet denomination of said selected game. More preferably, said denomination images displaying step comprises displaying said denomination images in response to a trigger event. In one preferred form, said trigger event is a player-actuated trigger event. In one particularly preferred form, said player-actuated trigger event comprises selection of a bet denomination image on said display.

Preferably, said method further comprises the step of displaying a default denomination image prior to said player selecting one of said denomination images. More preferably, said default denomination image displaying step comprises displaying the denomination image that was last selected on said electronic gaming machine.

The method preferably has the preferred features of the first aspect of the invention where applicable.

A fourth aspect of the present invention provides a gaming method for an electronic gaming machine comprising a housing having a display for displaying a game, wherein said game comprises game symbols and predetermined winning combinations of randomly selected game symbols in said game award prizes to a player; an electronic game controller inside said housing for controlling the display of said game symbols for playing said game on said display; and an input means for receiving commands from said player to operate said electronic gaming machine, said input means being in electronic communication with said electronic game controller, the method comprising:

said electronic game controller receiving a command from said player via said input means to initiate play of said game on said display;

said electronic game controller offering a plurality of bonus prize sets, each bonus prize set comprising at least one progressive jackpot prize, some of said bonus prize sets being available for selection by said player depending on a designated player selection;

in response to said player making said designated player selection via said input means, said electronic game controller transmitting a signal to said display to show said available bonus prize sets for selection by said player in a play of said game;

in response to said player selecting one of said available bonus prize sets, said electronic game controller making said selected available bonus prize set active for one or more subsequent plays of said game;

said electronic game controller commencing said play of said game by randomly selecting game symbols and transmitting a signal to said display to display said randomly selected game symbols;

said electronic game controller determining whether a bonus prize trigger event has occurred in said one or more subsequent plays and in response to the occurrence of said bonus prize trigger event, causing said electronic gaming machine to award one or more of said bonus prizes of said selected bonus prize set to said player; and

said electronic game controller, in response to a command by said player via said input means, changing said selected bonus prize set to another available bonus prize set in said one or more subsequent plays.

The method of the fourth aspect of the invention preferably has the preferred features of the third aspect of the invention stated above, where applicable.

According to a fifth aspect of the invention, there is provided a computer system comprising a central processing unit configured for communication with an electronic gaming machine, wherein said computer system is configured to perform the method of the third or fourth aspects of the invention.

According to a sixth aspect of the invention, there is provided a computer programme configured to perform the method of the third or fourth aspects of the invention.

According to a seventh aspect of the invention, there is provided a non-transitory carrier medium carrying computer executable code that, when executed on a central processing unit configured for communication with an electronic gaming machine, causes the central processing unit to perform the method of the third or fourth aspects of the invention.

Unless the context clearly requires otherwise, throughout the description and the claims, the words “comprise”, “comprising”, and the like are to be construed in an inclusive sense as opposed to an exclusive or exhaustive sense; that is to say, in the sense of “including, but not limited to”.

Furthermore, as used herein and unless otherwise specified, the use of the ordinal adjectives “first”, “second”, “third”, etc., to describe a common object, merely indicate that different instances of like objects are being referred to, and are not intended to imply that the objects so described must be in a given sequence, either temporally, spatially, in ranking, or in any other manner.

### BRIEF DESCRIPTION OF THE DRAWINGS

Preferred embodiments of the invention will now be described, by way of example only, with reference to the accompanying drawings in which:

FIG. 1 is a perspective view of an electronic gaming machine according to an embodiment of the invention;

FIG. 2 is a schematic drawing of an electronic game controller for the electronic gaming machine of FIG. 1;

FIG. 3 is a simulated screen shot illustrating a game played on the electronic gaming machine of FIG. 1;

FIG. 4 is a simulated screen shot illustrating an upper display area of the display of the electronic gaming machine of FIG. 1;

FIG. 5 is a simulated screen shot illustrating a selection screen displayed on the electronic gaming machine of FIG. 1 according to one embodiment of the invention; and

FIG. 6 is a simulated screen shot illustrating a selection screen displayed on the electronic gaming machine of FIG. 1 according to another embodiment of the invention.

FIG. 7 is a perspective view of an electronic gaming machine according to yet another embodiment of the invention;

FIG. 8 is a schematic drawing of a control panel for the electronic gaming machine of FIG. 7; and

FIG. 9 is a block diagram of the electronic components of the electronic gaming machine of FIG. 7.

### DETAILED DESCRIPTION OF VARIOUS EMBODIMENTS

The present invention will now be described with reference to the following examples which should be considered in all respects as illustrative and non-restrictive. In the Figures, corresponding features within the same embodiment or common to different embodiments have been given the same reference numerals.

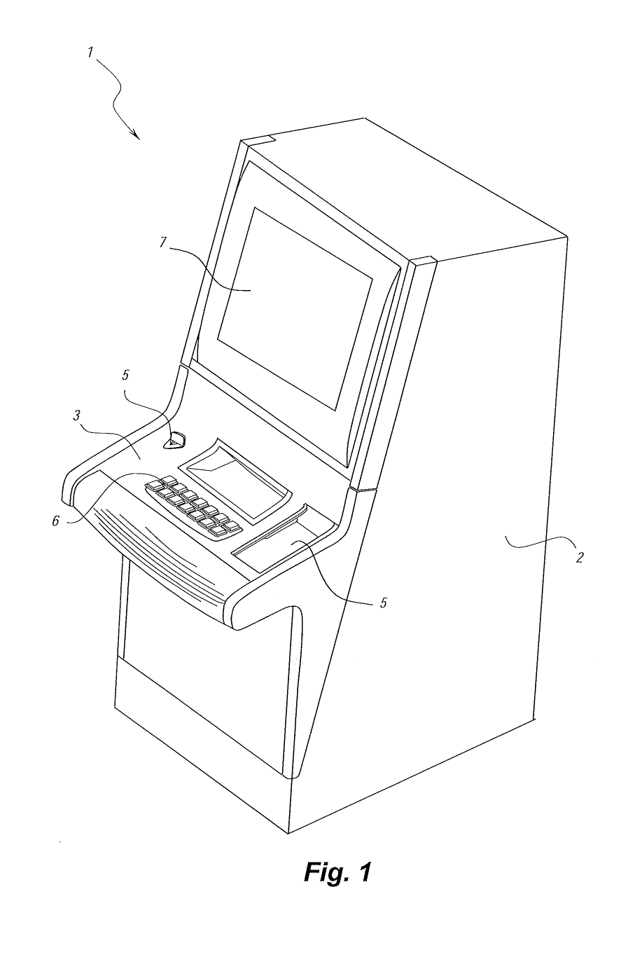

Referring to FIG. 1, an electronic gaming machine 1 according to a first embodiment of the invention includes a cabinet 2, a console 3 and an internal electronic game controller 4. The console 3 has various input devices including vending slots 5 for receiving monetary bets and a plurality of buttons 6 for actuation by a player. It will be appreciated that in other embodiments the vending slots 5 may be replaced with other types of value input/value output devices, such as a coin acceptor, a paper currency acceptor, a ticket reader and/or printer or a card reader and/or writer.

The vending slots 5 can be configured to receive value, such as cash in the form of banknotes and coins, or credits representing a monetary amount from a memory device, such as but not limited to a memory card, smart card, a radio frequency identification (RFID) device, USB key, magnetic card or other electronic storage device. Typically, the memory device is a credit card, debit card or other card that enables the transfer of monetary credit to the electronic gaming machine 1. Other forms of value include gaming tokens, paper, tickets, vouchers, and any other object representative of value.

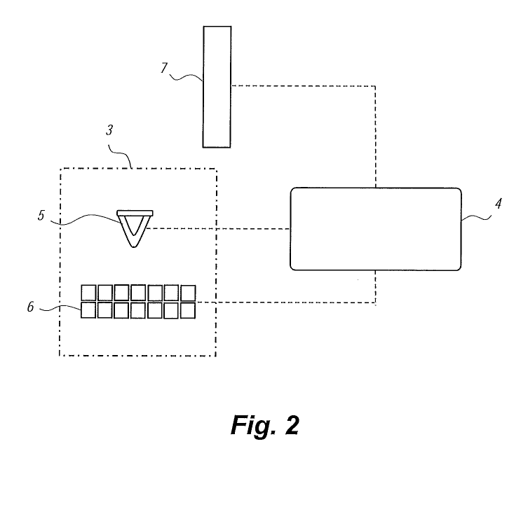

The electronic game controller 4 is generally in the form of a central processing unit, such as a computer, and is in electronic communication with a display in the form of a video display screen 7, as well as various input devices on the console 3, as best shown in FIG. 2. Typically, the electronic game controller 4 also comprises a random access memory (RAM) associated with the central processing unit, the RAM being used to store programme instructions and transient data related to the operation of the electronic game controller and hence the electronic gaming machine 1. The RAM contains a body of program instructions for implementing a game on the electronic gaming machine 1, as discussed in more detail below. The central processing unit or processor may also be operatively associated with a further storage device, such as a hard disk drive, which is used for long-term storage of program components and data relating to the electronic game controller 4 and/or the electronic gaming machine 1, including a database for game performance data, as well as information gathered from users. It is also appreciated that a person skilled in the art would readily understand the location and use of the electronic game controller 4 in the electronic gaming machine 1.

The electronic game controller 4 will transmit and receive signals to and from each of the input devices and the display 7, usually via wired connections but can include wireless modes of electronic communication, such as WLAN. In the case of the vending slots 5 (or with any other type of value transfer mechanism), there may be an intermediate credit verification device that examines and verifies the cash or credits received by the vending slots. Once the value (such as cash or credits) have been verified by the credit verification device, a signal is sent to the electronic game controller 4, which then determines whether the minimum bet level has been reached. If so, the electronic game controller 4 will permits play of the game on the electronic gaming machine 1. If not, the electronic game controller 4 will send a signal to the display 7 to show a message requesting further value to be added to the electronic gaming machine 1.

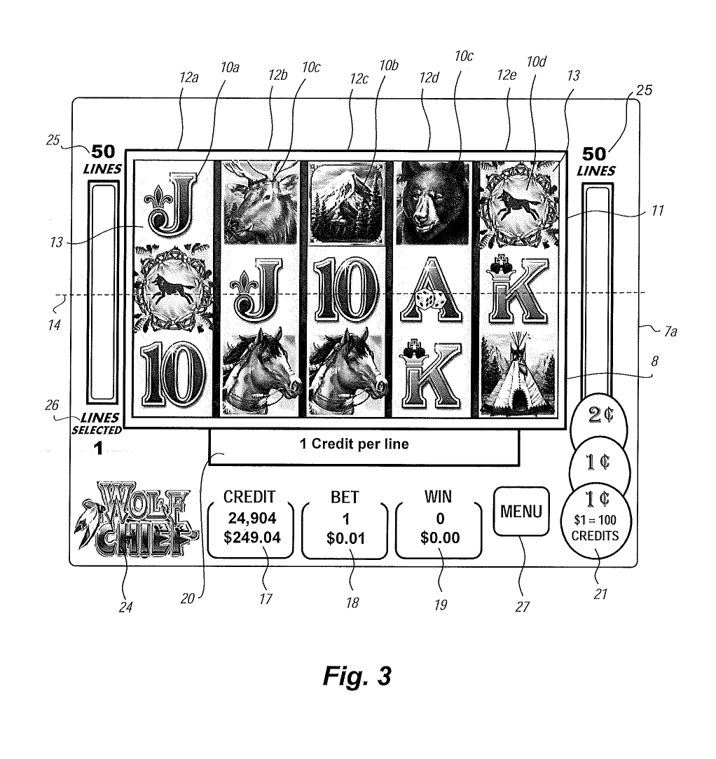

The electronic game controller 4 is programmed to provide a game in the form of a base game 8 (as best shown in FIG. 3) and a feature game 9 (now shown) on a lower playing area 7a of the display 7 of the electronic gaming machine 1 for play by a player. The base game 8 has game symbols 10 arranged into an array 11 in the form of five columns or “reels” 12. The reels 12 give the visual appearance of rotating, typically by having the game symbols 10 move in a downward linear path along the length of each reel 12. While the array 11 is arranged with five reels 12 and three rows as per the industry standard, it will be appreciated by one skilled in the art that other types of arrays could be used, such as 3×3, 4×3, 5×5, 4×4, etc, including arrays having an irregular number of rows and/or columns. For example, the array 11 can have an unequal number of rows and/or columns, where some columns have less or more rows than other columns or where some rows have less or more columns than other rows. A more specific example would be an array having three columns with only two rows and two columns with three rows. The electronic game controller 4 will transmit signals to the display screen 7 to cause the base game 8 and feature game 9 to be played on the lower playing area 7a, including showing the game symbols 10, array 11 and other visible elements of the games.

The array 11 of the base game 8 defines predetermined symbol positions 13, in which the game symbols 10 appear. The symbol positions 13 are not visually marked by boundary lines and simply provide an area for the game symbols 10 to appear. However, it will be appreciated that in other embodiments, the symbol positions 13 are defined by visible boundary lines (to define “squares” or game positions) or other markings to define each respective area of the symbol positions.

The array 11 is arranged so that a player can select one or more predetermined “pay lines” 14 defined around the array, which correspond to combinations of the symbol or game positions 13. The pay lines 14 correspond to the lines selected by the player and generally comprise at least one game position or symbol position 13 from each reel 12. The number of pay lines 14 that can be selected by the player depends on the amount of the monetary bet for playing a game on the array 11. In the base game 8, predetermined winning combinations of randomly selected game symbols 10 result in the award of prizes to the player.

The game symbols 10 can include a mixture of picture symbols (such as animal symbols or playing card symbols), word symbols, scatter symbols, substitute or wild card symbols and trigger symbols. Those skilled in the art will readily understand that a substitute symbol is able to act as any other game symbol, and hence is also known as a “wild card” symbol. Likewise, those skilled in the art will readily understand that a scatter symbol is a symbol that triggers a game event or confers an award without having to appear on a player-selected pay line 14. Similarly, a trigger symbol is a symbol that triggers a game event (like activating a feature game) or confers an award, where the trigger symbol may or may not have to appear in combination and may or may not have to appear on the same player-selected pay line 14. In this embodiment, the game symbols 10 include playing card symbols 10a, item-themed symbols 10b, animal-themed symbols 10c, substitute or wild card symbols in the form of wolf image symbol 10d and a scatter symbol in the form of a horse symbol 10e. The electronic game controller 4 randomly determines the appearance of the game symbols 10 on the array 11.

The lower playing area 7a of the video screen 7 also displays other standard game information including the amount of player credits 17, the amount of the current bet wagered by the player 18, the amount of wins by the player 19, a message area 20, a current denomination button 21 indicating the currently selected base bet denomination, the name 24 of the game “Wolf Chief” being played. Other standard information includes the number of pay lines available 25, the number of player-selected pay lines 26 and a menu button for bringing up a menu screen 27 (typically explaining the game rules and showing the available pay lines 14).

In the base game 8, the player initially makes a bet using vending slots 5 to initiate play of the electronic gaming machine 1 by building up credit to play the base game 8 on the electronic gaming machine. For example, the player can bet or wager monetary amounts equivalent to a particular amount of credits, depending on the bet denomination selected for the base game. Also, the player can make any additional side bets or ante-bets during play of the base game 8 once the base game has commenced to access additional features in the base game, such as increasing the number of winning combinations in the base game.

Typically, electronic gaming machines offer a number of preset bet options that the player can make, and these bet options can vary depending on the game or games offered on the electronic gaming machine. For example, a game on an electronic gaming machine may provide bet options of 1 credit, 2 credits, 5 credits and 10 credits per player-selected pay line 14. In another example, the player may bet 1 credit, 2 credits, 5 credits and 10 credits for a preset group or combination of pay lines 14, such as a group of 5 pay lines, 10 pay lines, 20 pay lines, etc.

The electronic gaming machine 1 also has a default bet denomination, which is usually the bet denomination that was previously used in the preceding play of the base game 8. For example, if a person had played the base game 8 with a bet denomination of 5¢, then this would be the default bet denomination for the player when he or she commences play of the game. Where the electronic gaming machine has not yet been played or has been started up, the default bet denomination is initially selected by the electronic game controller 4. The default bet denomination can be randomly selected or chosen according to a predetermined order. Usually, the electronic game controller 4 will select the bet denomination with the lowest value that is available for the base game 8, which would be the 1¢ bet denomination for this embodiment. The player may change the bet denomination at any time in the base game 8 by touching the denomination button 21 before or after the reels 12 have spun. In this embodiment, touching the denomination button will bring denomination images 28, 29 that the player may select to quickly change the bet denomination between plays of the game 8.

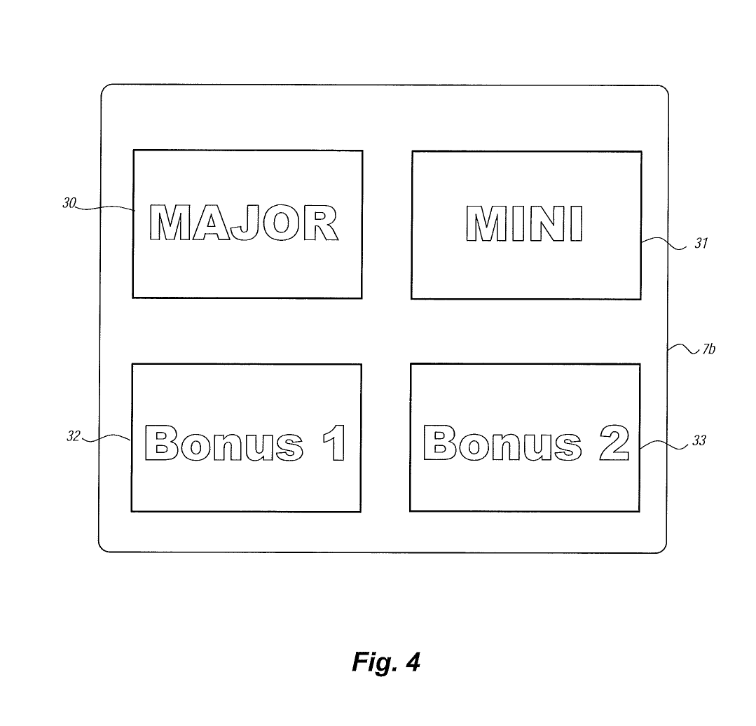

As best shown in FIG. 4, the video display screen 7 may also include an upper display area 7b, either as a separate display or integrated into the display screen 7, which provides jackpot information relating to available jackpots or bonus prizes in the game 8. In this embodiment, two of the jackpots are progressive jackpots, being the Major jackpot 30 and Mini jackpot 31, while two of the jackpots are fixed jackpots, being the Bonus 1 jackpot 32 and the Bonus 2 jackpot 33. The upper display area 7a ensures that the jackpot information is available to the player at all times during play of the electronic gaming machine 1.

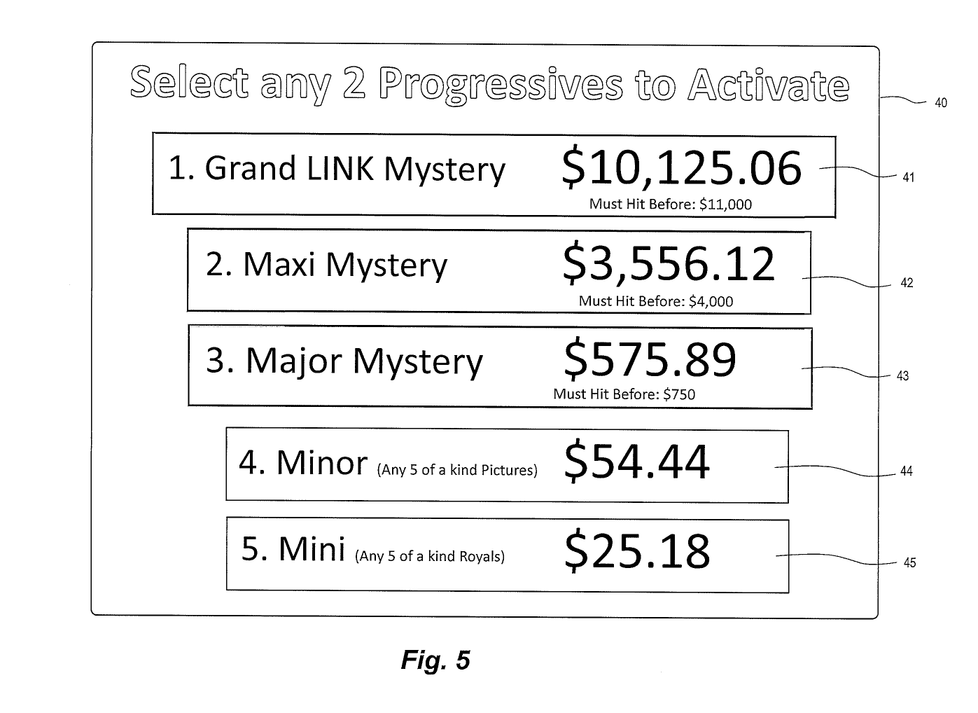

Once the player has commenced play of the game 8 by making an appropriate bet, the electronic game controller 4 sends a signal to the display 7 to show a selection screen 40, as best shown in FIG. 5. Where the display 7 is split into a lower playing area 7a and an upper display area 7b, the selection screen can be shown in either area. In the selection screen 40, the player is permitted to select one of several possible jackpot sets, which are composed of the available jackpots shown on screen. The selected jackpot set comprising the selected jackpots become active (i.e. can be won) during play of the game 8 (and feature game 9) on the electronic gaming machine 1. In this embodiment, the available jackpot sets are restricted to two of the available jackpots 41 to 45 shown on the selection screen 40.

The available jackpots and/or jackpot sets that the player may select depend on the bet that is made to play the base game 8. For example, if a player makes a minimum bet, then only a small portion or only one of the available jackpot sets become available for selection. Moreover, in other embodiments, not all of the jackpots in the available jackpot sets become available in the case of a minimum bet or bet that does not reach a threshold amount. Thus, the player must make a designated player selection in order to access all the jackpots in the available jackpot set(s). Also, the higher the bet that is made the larger the number of jackpots and/or jackpot sets become available. Alternatively or additionally, a higher bet results in available jackpot sets having jackpots of higher value and/or probability of being won. Conversely, the lower the bet that is made, there is a reduced availability of jackpots and/or jackpot sets that become available, or available jackpot sets only have jackpots of lower value or jackpots of higher value with a reduced probability of being won.

It is preferred that at least one of the available jackpots is not active during play of the game(s) on the electronic gaming machine 1 once the jackpot set has been selected by the player in order to allow the player to balance the risk of not winning an “inactive” jackpot that may be triggered during game play against selecting a more desirable jackpot to be won. However, in other embodiments all the available jackpot sets are active during game play. In a further alternative, only one of the available jackpot sets is active during game play.

In other embodiments, the designated player selection is not directly tied to the bet made, but is indirectly linked to the bet made. This is implemented by making the designated player selection being linked to the bet denomination selected to play the game and/or the number of lines that are to be played.

The offered jackpots 41 to 45 in this jackpot set comprise progressive jackpots. A progressive jackpot prize takes a portion of each bet (typically a set percentage of each bet) made on the electronic gaming machine and thus the amount of the progressive jackpot incrementally increases as more bets are made on the electronic gaming machine 1. The progressive jackpot is typically awarded when a winning game combination associated with the jackpot occurs in the game played on the electronic gaming machine. In many cases, progressive jackpots are associated with the least probable winning combination and are commonly the highest paying award of the electronic gaming machine. In other cases, a separate trigger event can be used to award the progressive jackpot prize, such as a special jackpot symbol, a trigger event internally generated by the electronic game controller. Alternatively, or additionally, once a certain threshold is met, either a certain amount that has been bet on the electronic gaming machine or the incremented amount of the progressive jackpot, a trigger event is activated in the electronic gaming machine to pay out the progressive jackpot prize. Progressive jackpot prizes also tend to be shared amongst multiple electronic gaming machines so as to increase the amount of the progressive jackpot prize and hence increase player interest in playing one of the electronic gaming machines. In some electronic gaming machines, more than one jackpot or progressive jackpot is offered by the electronic gaming machine or electronic gaming machines linked together.

As stated at the top of the selection screen 40 shown in FIG. 5, the player in this embodiment is prompted to select any two progressive jackpots of the five progressive jackpots 41 to 45 to form the selected jackpot set to be active (i.e. won) during play of the game 8 on the electronic gaming machine 1. The progressive jackpots comprise a Grand LINK Mystery jackpot 41, a Maxi Mystery jackpot 42, a Major Mystery jackpot 43, a Minor jackpot 44 and a Mini jackpot 45. As indicated by their names, the Grand LINK Mystery jackpot 41, Maxi Mystery jackpot 42 and Major Mystery jackpot 43 are mystery jackpots rather than symbol driven jackpots. That is, none of the symbols in the game trigger the jackpot; hence the trigger event is a “mystery”. By way of comparison, a standard jackpot is typically symbol driven in that a particular combination of symbols must occur in the game to trigger the standard jackpot.

The trigger event for the mystery jackpot can be one randomly generated by the electronic game controller 4 for each play of the game 8. One way to implement the random determination of the trigger event is for the electronic game controller 4 to internally generate a random number and check if it is a predetermined number or within a predetermined range of numbers that will initiate the appearance of the trigger symbols. For example, the predetermined range of numbers could be the range of numbers between 1 and 10 and the electronic game controller 4 internally generates a random number between 1 and 100. If the generated number is any one of numbers 1 to 10, then this results in the electronic game controller 4 causing the trigger event to occur and award the progressive jackpot prize. It will be appreciated that this manner of determining the trigger event may also be used to determine whether the feature game 9 is triggered in the base game 8.

The Grand LINK Mystery jackpot 41, Maxi Mystery jackpot 42 and Major Mystery jackpot 43 also must be won before reaching a predetermined monetary limit; the Grand LINK Mystery jackpot 41 must be won (or “hit”) before it reaches $11,000, the Maxi Mystery jackpot 42 must be won before it reaches $4,000 and the Major Mystery jackpot 43 must be won before it reaches $750. The electronic game controller 4 internally monitors the amounts of the Grand LINK Mystery jackpot 41, Maxi Mystery jackpot 42 and Major Mystery jackpot 43. Once any one of these jackpots would reach their respective monetary limit with the next incremental contribution from the electronic gaming machine 1, the electronic game controller 4 causes the relevant jackpot to be won before the next incremental contribution is added to the relevant jackpot.

The Maxi Mystery and Major Mystery progressive jackpot prizes 42 and 43 are typically confined to the electronic gaming machine 1 as so called “standalone” progressive jackpots. The Grand LINK Mystery jackpot 41 is a wide area or an in-house linked progressive jackpot prize. In other embodiments, one or more the progressive jackpot prizes 41 to 45 are configured to be part of a wide area or in-house linked progressive jackpot prize. In other words, the progressive jackpot prizes 41 to 45 can be awarded on a group of networked gaming machines in a specified area or a group of specified electronic gaming machines that are linked together for jackpot purposes (usually via a central jackpot controller). The jackpot prizes can also be shared with any other games offered on the same electronic gaming machine 1 (as in multi-game gaming machines).

The Minor jackpot 44 and Mini jackpot 45 are standard symbol driven jackpots. The Minor jackpot 44 requires the combination of five of a kind of the same picture symbol (item or animal-themed symbols 10b, 10c) before it is awarded, whereas the Mini jackpot 45 requires the combination of five of a kind of the same royal playing card symbol (being the Ace, King, Queen and Jack playing card symbols 10a, but not the 9 or 10 playing card symbols) before it is awarded.

After making the selection(s) of the jackpots for the base game 8, the electronic game controller 4 then transmits a signal to the display 7 to make reels 12 to appear to visibly rotate or “spin” in a linear path, typically in a downward vertical direction, and randomly display the game symbols 10 in each symbol position 13 for each play of the array 11 for the base game 8. After the reels 12 stop spinning, the electronic game controller 4 determines whether there are any predetermined winning combinations of the game symbols 10 appearing in any player-selected pay lines 14, such as a two of a kind, three of a kind, four of a kind or five of a kind for all the game symbols 10 and other combinations of a “full house”, “straight” or “flush” for the playing card game symbols 10a. It will be appreciated that other winning combinations of game symbols 9 can also be provided. If so, the gaming machine 1 enters a winning game state and awards a prize according to the displayed predetermined winning combination.

The electronic game controller 4 also determines whether the feature game 9 should be activated, based on a predetermined trigger event, such as the appearance of three scatter symbols 10e appearing in a play or spin of the base game 8. The scatter symbols 10e need not appear on the same pay line 14, but can appear on any of the player-selected pay lines.

The electronic game controller 4 then transmits a signal to the video screen 7 to cause the feature game 9 to appear on the video screen 7. The feature game 9 also uses the same game symbols 10 as the base game 8, as well as the same array 11, reels 12a to 12e, symbol positions 13 and player-selectable pay lines 14 on the video screen 7. In the feature game 9, ten free plays or spins of the feature game are awarded to the player without having to make an additional bet or wager. It will be understood by those skilled in the art that a free play or spin involves a play of the game without requiring any bet to be made by the player, and that any number of free spins can be chosen for the feature game. In addition, it will be appreciated that in the art free plays or spins are commonly referred to as “free games”. The number of free games remaining in the feature game 9 may be indicated by a counter shown near the array 11 on the screen 7. Typically, the prizes awarded for the same winning combinations of game symbols in the feature game 9 are of higher value than the prizes awarded in the base game 8.

During play of the base game 8 and/or feature game 9, the electronic game controller will determine whether a trigger event for any of the selected jackpots has occurred, as described above. In response to the occurrence of the jackpot trigger event(s), the electronic game controller 4 transmits a signal to the video screen 7 to cause the jackpot(s) associated with the jackpot trigger event(s) to be awarded to the player. After the jackpot(s) are awarded, their values are reset and game play of the electronic gaming machine 1 continues as before. The values of the jackpots that have been won can be reset either to a predetermined start value or simply increment upwardly from zero where the won jackpot is a progressive jackpot.

In addition, contributions of portions of the bet made to play the game are only made for the selected jackpots that are active. In this way, the player's bets do not contribute towards jackpots that the player cannot win.

Between plays or spins of the base game 8 and/or feature game 9, the player can acuate the menu button 27 and cause the selection screen 40 to appear so that the player can change his or her selection of the available jackpot sets.

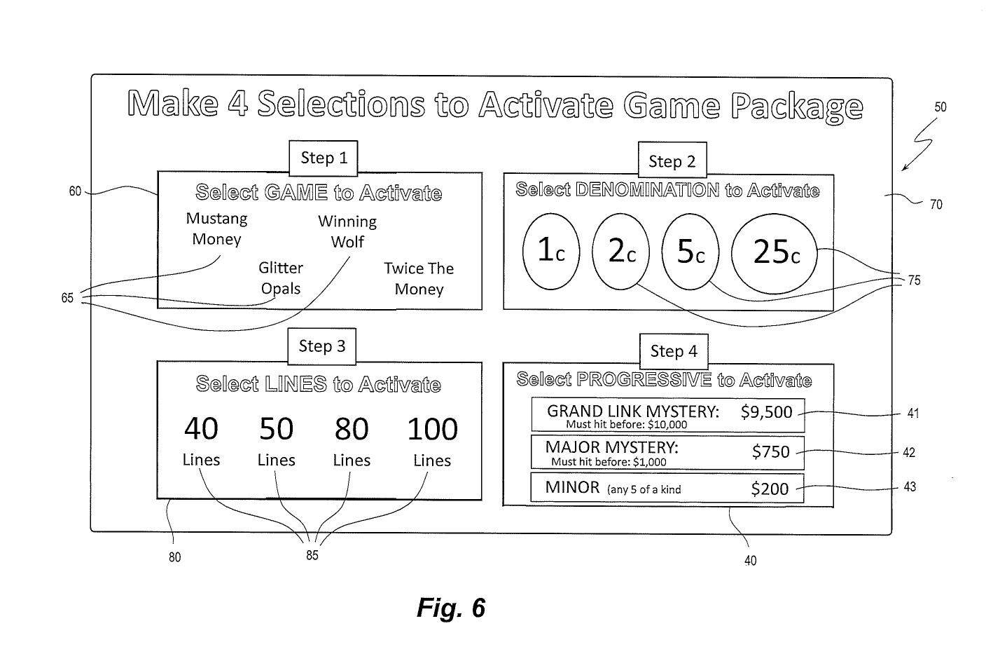

Referring to FIG. 6, another embodiment of the invention is shown, where the selection screen 50 includes the ability for the player to configure other options in addition to the jackpots for the game. In addition to the selection screen 40, the player may select one of several games offered by the electronic gaming machine via game selection screen 60; select one of the bet denominations available for the selected game via denomination selection screen 70 and select the number of pay lines available for the selected game and denomination via the line selection screen 80. As shown in FIG. 6, the player is prompted to select, in order, firstly one of the games 65 presented on the game selection screen 60; secondly, one of the bet denominations 75 available for the selected game on the denomination selection screen 70; thirdly, one of the number of pay lines available for the selected game and bet denomination via the line selection screen 80; and fourthly, select the jackpots 41 to 45 available via the jackpot selection screen 40, as described above.

It will be appreciated that in other embodiments, the order of selection can be reversed or interchanged as required. For example, if the bet denomination were selected first, then the game selection screen 60 would only show games that were available with the selected bet denomination. Likewise, if the number of lines were selected first, then the game selection screen 60 or the denomination screen 70 (depending on which is to be selected after the selection of the number of lines) would show only games and bet denominations available for the selected number of lines. Finally, where the jackpots are first selected, then only the games, bet denominations and lines would be shown on the game selection screen 60, the denomination screen 70 and line selection screen 80, respectively, that are available for the selected jackpot(s).

Where the player has selected the bet denomination for the base game 8, the amounts of the jackpots in the selected jackpot set(s) are multiplied by the value of the bet denomination. Hence, a bet denomination of 1¢ would not increase the value of the selected jackpots, but if the bet denomination selected by the player was 5¢, then the amounts of the selected jackpots would be multiplied by five. In other embodiments, the amounts of the jackpots may be changed in response to player selections. For example, the amounts of the selected jackpots may reduce if the player reduces the number of lines played, the bet denomination or the overall bet. Similarly, the amounts may increase if the player increases the number of lines played, the bet denomination or the overall bet.

While the selection screens 40, 60, 70 and 80 are shown in a single selection screen 50 in this embodiment, it will be appreciated that in other embodiments, the various steps in selecting each option, including the jackpot set option, are implemented by bringing up an individual selection screens for each configuration option. Examples of this implementation for the game, bet denomination and line selection screens are described in the Applicant's Australian Innovation Patent No. 2013101568, whose specification is hereby incorporated by reference in its entirety. In yet another embodiment, both individual and combined selection screens are used, such as an individual screen for the jackpot selection screen 40 while the other options of games, bet denominations and lines are selected using a combined selection screen similar to that shown in FIG. 6.

In other embodiments, the electronic gaming machine 1 also offers the player the opportunity to play in community games against other players in so-called tournament games, or even in player versus player games. This is typically implemented by electronically linking several electronic gaming machines 1 in a group within a gaming venue. The player versus player or tournament game can be played simultaneously by the players or can be staggered, with some players playing at one time and some players playing at another time in the same game. In this situation, the player versus player or tournament game comprises the award of an additional bonus prize in addition to the jackpot prizes in said selected available jackpot set.

It will be appreciated that in other embodiments, game enhancing elements can be awarded in the feature game 9 in addition or as an alternative to the enhanced prizes awarded based on winning combinations of game symbols. The award of game enhancing elements can be done by way of a sixth reel or the appearance of game enhancing symbols in the reels 12a to 12e. A variety of game enhancing elements can be awarded by the game enhancing symbols, including:
symbols that award a predetermined number of free plays of said game;
win multiplier symbols that multiply the amount of any win from one of said predetermined winning combinations;
“wild” symbols that cause the display of substitute symbols in randomly selected symbol positions;
bonus symbols that awards a bonus prize, either as a monetary amount or as a bonus credit;
wild multiplier symbols that cause the display of substitute symbols on the array 11 and multiplies the amount of any win from one of said predetermined winning combinations;
bonus wild symbols that cause the display of substitute symbols on the array 11 and awards a bonus prize;
symbols that cause the award of additional free plays of said game;
symbols that cause one or more of said symbol positions to be held static (typically one or more reels 12a to 12e) and display substitute symbols on the array 11;
symbols that cause the same game symbol to be stacked in a group of symbol positions, typically the group being one or more reels 12a to 12e;
symbols that cause the display of new game symbols on the array 11;
“reveal” symbols that cause a game symbol to reveal another game symbol; and
“replacement” symbols that cause one or more game symbols to be replaced by other game symbols in the array 11.

These game enhancing symbols do not modify the function or value of the game symbols 10 that appear on the arrays 11, but instead confer bonus prizes, free games or change existing game symbols for other game symbols (such as replacing picture, royal card or symbols belonging to a reel with wild/substitute symbols). Where the function of game symbols 10 have been changed or the game symbols 10 are replaced, then this modification can take effect with the next play of the game instead of applying to the result of the spun array 11. In another embodiment, the game enhancing symbols may indicate the duration in which its game enhancing element is applied, such as a predetermined number of spins or a predetermined time period.

In other embodiments, the game enhancing symbols include “collector”-type game enhancing symbols which award points or tokens. The collection of points or tokens during the base game 8 and/or feature game 9 leads to the trigger of additional prizes or game enhancing symbols, depending on the number of points or tokens that are collected. These additional prizes can include stand alone progressive jackpots, bonus prizes and super games, which are enhanced versions of free spins or games where there are greater pay outs or frequency of wins.

Also, the arrangement of the game 8 as shown in FIG. 3 is not limited to a set of reels or columns, but could take other forms, such as non-rectangular arrays (i.e. arrays that do not comprise rows and columns). For example, where the array is circular, the predetermined game positions can take the form of pie-shaped slices or wedges.

While the same game format is essentially used across the base game 8 and feature game 9, it will be appreciated that the game format may vary across the base and feature games, as well as between base games where more than one game is offered by the same electronic gaming machine 1. For example, one of the games 8 may be a wheel-type game or a four reel game and another of the games may be a standard five reel game. Similarly, the games 8 may each have different game symbols, game rules and pay tables that are unique to each game.

While one embodiment of the invention has been described in relation to a base game 8 and a feature game 9, it will be appreciated that the invention could include one or more additional feature games that are triggered by specific trigger symbols appearing in the feature game 9. Also, the additional feature games may also have trigger symbols that trigger further feature games in a cascading fashion. These additional and further feature games could have the same game play elements as the feature game 9 or be different feature games entirely.

Furthermore, the embodiments of the invention have been described as providing a standard 5×3 set of reels 12 for the base game 8. However, it will be appreciated that in other embodiments, the size and shape of the reels 12 may vary. For example, the array 11 could take any number of different shapes, such as triangular, circular, square, hexagonal, hemi-spherical or other polygonal shapes. Alternatively, the arrays 11 could have an uneven number of rows and/or columns. For example, the reels 12a, 12b could have three rows, but the reels 12c to 12e could have four rows.

In other embodiments, the base game 8 (and the feature game) need not be displayed on a single video screen 7. Instead, they may be displayed on separate video screens, with the lower playing area 7a appearing in a lower video screen and the upper display area 7b on an upper video screen. Also, the order can be reversed, with the playing area 7a appearing on an upper video screen or upper part of a single video display screen 7 and the display area 7b appearing on a lower video screen or lower part of a single video display screen.

In another embodiment, the video screen 7 is a touch screen for use in addition to the player-actuatable buttons 6 so as to enable the player to select the bet level (such as bet denominations or bet per pay line 14) as well as other various features, such as making monetary bets for the game, initiating play of any base and feature games played and responding to any messages or requests issued on the electronic gaming machine 1 by the electronic game controller 4. In this case, the player may control when the reels 12 start spinning and stop spinning, either individually or collectively, by simply touching the reels 12. Control over spinning of the reels 12 can also be implemented through the buttons 6 on the console 3. This increases player interaction and provide the player with an opportunity to guess when a particular game symbol 10 may appear in the reels 12.

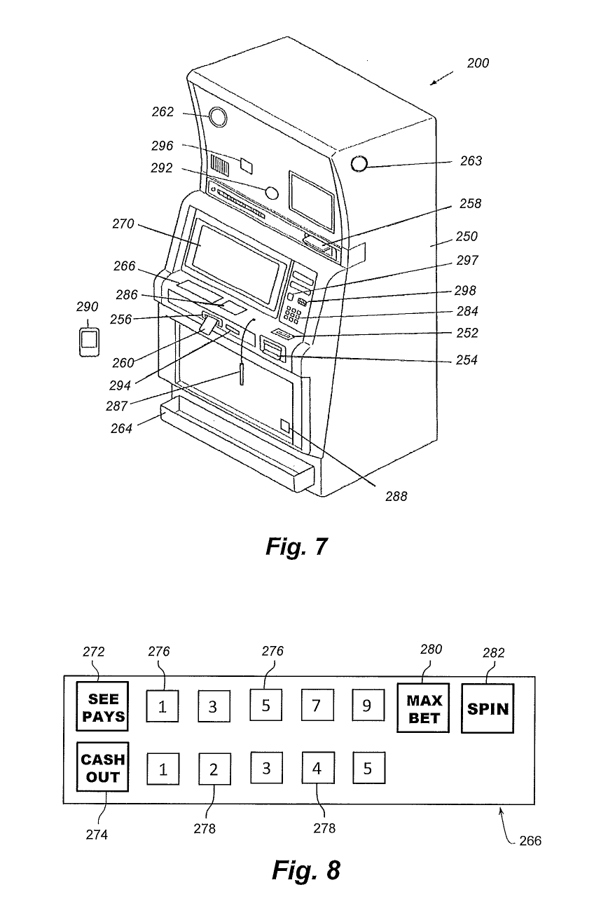

Referring to FIG. 7, another embodiment of the invention is shown in the form of an electronic gaming machine 200. The electronic gaming machine 200 may include a housing or cabinet 250 and one or more value transfer mechanisms or devices, which may include a coin slot or acceptor 252, a paper currency or bill acceptor 254, a ticket reader/printer 256 and a card reader 258, which may be used to input value to the electronic gaming machine 200. A value transfer device may include any device that can accept value from a player. The topper (not shown) may be mounted to the top of the electronic gaming machine 200.

If provided on the electronic gaming machine 200, the ticket reader/printer 256 may be used to read and/or print or otherwise encode ticket vouchers 260. The ticket vouchers 260 may be composed of paper or another printable or encodable material and may have one or more of the following informational items printed or encoded thereon: the casino name, the type of ticket voucher, a validation number, a bar code with control and/or security data, the date and time of issuance of the ticket voucher, redemption instructions and restrictions, a description of an award, and any other information that may be necessary or desirable. Different types of ticket vouchers 260 could be used, such as bonus ticket vouchers, cash-redemption ticket vouchers, casino chip ticket vouchers, extra game play ticket vouchers, merchandise ticket vouchers, restaurant ticket vouchers, show ticket vouchers, etc. The ticket vouchers 260 could be printed with an optically readable material such as ink, or data on the ticket vouchers 260 could be magnetically encoded. The ticket reader/printer 256 may be provided with the ability to both read and print ticket vouchers 260, or it may be provided with the ability to only read or only print or encode ticket vouchers 260. In the latter case, for example, some of the electronic gaming machines 200 may have ticket printers 256 that may be used to print ticket vouchers 260, which could then be used by a player in other electronic gaming machines 200 that have ticket readers 256.

If provided, the card reader 258 may include any type of card reading device, such as a magnetic card reader or an optical card reader, and may be used to read data from a card offered by a player, such as a credit card or a player tracking card. If provided for player tracking purposes, the card reader 258 may be used to read data from, and/or write data to, player tracking cards that are capable of storing data representing the identity of a player, the identity of a casino, the players gaming habits, etc.

The electronic gaming machine 200 may include one or more audio speakers 262, a coin payout tray 264, an input control panel 266, and a colour video display unit 270 for displaying images relating to the game or games provided by the electronic gaming machine 200. The audio speakers 262 may generate audio representing sounds such as the noise of spinning reels, a dealer's voice, music, announcements or any other audio related to a game. The input control panel 266 may be provided with a plurality of pushbuttons or touch-sensitive areas that may be pressed by a player to select games, make wagers, make gaming decisions, etc.

FIG. 8 illustrates one possible embodiment of the control panel 266, which may be used where the electronic gaming machine 200 having a plurality of reels. The control panel 266 may include a “See Pays” button 272 that, when activated, causes the display unit 270 to generate one or more display screens showing the odds or payout information for the game or games provided by the electronic gaming machine 200. As used herein, the term “button” is intended to encompass any device that allows a player to make an input, such as an input device that must be depressed to make an input selection or a display area that a player may simply touch. The control panel 266 may include a “Cash Out” button 274 that may be activated when a player decides to terminate play on the electronic gaming machine 200, in which case the electronic gaming machine 200 may return value to the player, such as by returning a number of coins to the player via the payout tray 264.

The control panel 266 may be provided with a plurality of selection buttons 276, each of which allows the player to select a different number of pay lines prior to spinning the reels. For example, five buttons 276 may be provided, each of which may allow a player to select one, three, five, seven or nine pay lines.

The control panel 266 may also be provided with a plurality of selection buttons 78 each of which allows a player to specify a wager amount for each pay line selected. For example, the electronic gaming machine 200 may be provided with five selection buttons 78, each of which may allow a player to select 1¢, 2¢, 5¢, 10¢ and 20¢, to wager for each pay line selected. In that case, if a player were to activate one of the buttons 276 to select five pay lines and then activate one of the buttons 278 to select 5¢ per pay line to be wagered or bet, the total wager would be $0.25.

The control panel 266 may include a “Max Bet” button 280 to allow a player to make the maximum wager allowable for a game. In the above example, where up to nine pay lines were provided and up to 20¢ could be wagered for each pay line selected, the maximum wager would be $1.80 The control panel 266 may include a spin button 282 to allow the player to initiate spinning of the reels after a bet has been made.

In FIG. 8, a rectangle is shown around the buttons 272, 274, 276, 278, 280, 282. It should be understood that the rectangle simply designates, for ease of reference, an area in which the buttons 272, 274, 276, 278, 280, 282 may be located. Consequently, the term “control panel” should not be construed to imply that a panel or plate separate from the housing 250 of the electronic gaming machine 200 is required, and the term “control panel” may encompass a plurality or grouping of player activatable buttons.

Although one possible control panel 266 is described above, it should be understood that different buttons could be utilized in the control panel 266, and that the particular buttons used may depend on the game or games that could be played on the electronic gaming machine 200. Although the control panel 266 is shown to be separate from the display unit 270, it should be understood that the control panel 266 could be generated by the display unit 270. In that case, each of the buttons of the control panel 266 could be a coloured area generated by the display unit 270, and some type of mechanism may be associated with the display unit 270 to detect when each of the buttons was touched, such as a touch-sensitive screen.

As noted above, the electronic gaming machine 200 may include a mechanism by which the electronic gaming machine 200 may determine the identity of the player. In particular, the card reader 258 may be used to read a card that carries an identification code that may be uniquely associated with the player so that the gaming unit can differentiate that player from all other players, or so that the gaming unit can differentiate that player as a member of a group of players from all player not a member of the group of players. The electronic gaming machine 200 may also include equipment, such as a keypad 284, an input pad 286 (with optional stylus 287), a port (or antenna) 288 adapted to communicate via a wired or wireless link (infrared or radio frequency link, for example) to a mobile electronic device 290 (such as a personal digital assistant, smart phone or tablet), a camera 292, a scanner 294, a retinal (or iris) scanner 296, fingerprint scanner 297, and/or a microphone 298. The electronic gaming machine 200 may include any one of the devices 258, 284, 286, 288, 290, 292, 294, 296, 297, 298, or the electronic gaming machine 200 may include a combination of some or all of the devices 258, 284, 286, 287, 288, 290, 292, 294, 296, 297, 298.

In operation, a player may identify him or herself to the electronic gaming machine 200 by entering a unique numeric or alpha-numeric code using the key pad 284, for example. Alternatively, the player may use his or her finger or the stylus 287 to sign his or her signature on the input pad 286. As a further alternative, the player may sign his or her signature on the mobile electronic device 290, which signature is then converted to electronic data, and the data is then transferred via the port/antenna 288 to the electronic gaming machine 200. As yet another alternative, the player may sign his or her signature on a piece of paper that is then photographed using the camera 292 or scanned using the scanner 294 (or the bill acceptor 254) to convert the signature into electronic data. As an additional alternative, the player may place one of his or her fingers or his or her hand on the scanner 297, and the scanner 297 may generate an electronic data representation of the fingerprint on one or more of the player's fingers or an electronic data representation of the pattern of the entire hand. Alternatively, the camera 292 may be used to take a picture (live or still) of the player, the picture then being converted into electronic data. As a still further alternative, the player may place his or her eye up to the retinal (or iris) scanner 296, and the retinal (or iris) scanner 296 may generate an electronic data representation corresponding to the pattern of the retina (or iris) of the player. As yet another alternative, the player may speak into the microphone 298, and characteristics of the spoken words (or voiceprint) may be converted into an electronic data representation.

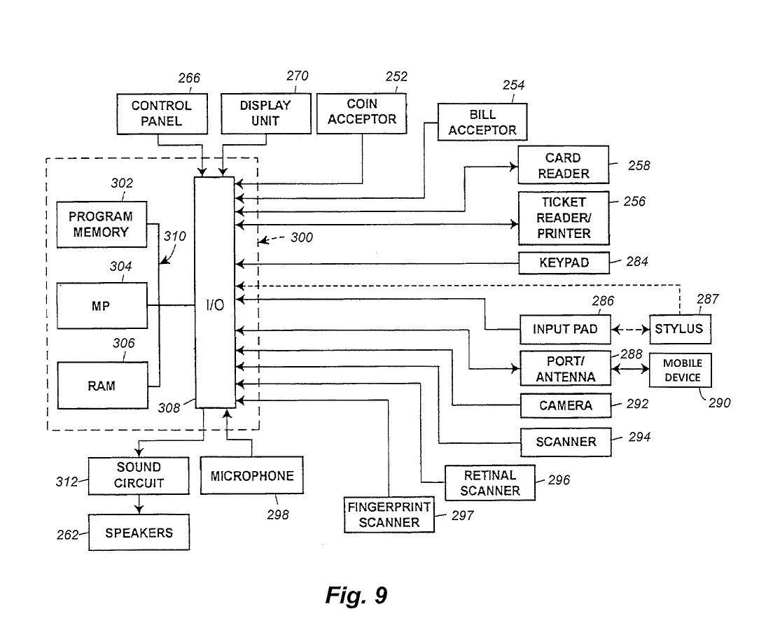

FIG. 9 is a block diagram of a number of components that may be incorporated in the electronic gaming machine 200. Referring to FIG. 9, the electronic gaming machine 200 may include a controller 300 that may comprise a program memory 302, a microcontroller or microprocessor (MP) 304, a random-access memory (RAM) 306 and an input/output (I/O) circuit 308, all of which may be interconnected via an address/data bus 310. It should be appreciated that although only one microprocessor 304 is shown, the controller 300 may include multiple microprocessors 304. Similarly, the memory of the controller 300 may include multiple RAMs 306 and multiple program memories 302. Although the I/O circuit 108 is shown as a single block, it should be appreciated that the I/O circuit 308 may include a number of different types of I/O circuits. The RAM(s) 304 and program memories 302 may be implemented as semiconductor memories, magnetically readable memories, and/or optically readable memories, for example.

FIG. 9 illustrates that the coin acceptor 252, the bill acceptor 254, the ticket reader/printer 256, the card reader 258, the control panel 266, the display unit 270, the keypad 284, the input pad 286 (and optionally the stylus 287), the port/antenna 288, the digital camera 292, the scanner 294, the retinal scanner 296, the fingerprint scanner 297 and the microphone 298 may be operatively coupled to the I/O circuit 308, each of those components being so coupled by either a unidirectional or bidirectional, single-line or multiple-line data link, which may depend on the design of the component that is used. The speaker(s) 262 may be operatively coupled to a sound circuit 312, that may comprise a voice- and sound-synthesis circuit or that may comprise a driver circuit. The sound-generating circuit 312 may be coupled to the I/O circuit 308.

As shown in FIG. 9, the components 252, 254, 256, 258, 266, 270, 284, 286, 287, 288, 292, 294, 296, 297, 298, 312 may be connected to the I/O circuit 308 via a respective direct line or conductor. Different connection schemes could be used. For example, one or more of the components shown in FIG. 8 may be connected to the I/O circuit 308 via a common bus or other data link that is shared by a number of components. Furthermore, some of the components may be directly connected to the microprocessor 304 without passing through the I/O circuit 308.

It will be appreciated that while the preferred embodiments have been described in relation to an industry standard electronic gaming machine, the invention can be readily applied to other types of electronic gaming machines, including a personal computer (standing alone or connected to a communications network, LAN or WAN), mobile electronic devices (such as handheld or portable electronic devices like tablets and smart phones) and other electronic devices capable of displaying a game. In the case of mobile electronic device, in one arrangement it may permit the player to make bets using “virtual” credits that represent a monetary value, but do not require the player to make a monetary transaction. Instead, the invention may provide a tiered access to the various features of the game so that the player can make relatively small payments to access particular features of the game or obtain additional benefits during game play. An alternative arrangement would require the player to purchase virtual credits or tokens via an interface on the mobile electronic device or an online interface accessible by the mobile electronic device. Similarly, either of the above described arrangements can be applied where the invention is implemented on a personal computer (PC) connected to the internet (wirelessly or not). In one example of the implementation, the PC would access an online casino over the internet to play the game of the invention or the game of the invention would be part of a social networking website. It is also contemplated that the player could also make regular payments to subscribe to continue playing the game on the mobile electronic device, PC or other electronic device.

In an alternative embodiment, the electronic gaming machine also provides an option for the player to play with either credits based on a monetary amount or virtual credits as discussed above. This can be implemented by way of a selection menu prior to playing the selected game or by providing a suitable menu button on screen during play of the selected game.

In another aspect, the invention includes a computer programme configured to perform the invention. In this way the invention can be implemented in various ways on an electronic gaming machine. In a further aspect, the invention includes a gaming system configured comprising a central processing unit (such as a computer or computational processor) configured for communication with an electronic gaming machine to perform the invention. In a yet another aspect, the invention includes a non-transitory computer readable or carrier medium carrying computer executable code that, when executed on a central processing unit configured for communication with an electronic gaming machine, causes said central processing unit to perform the invention. In this case, the non-transitory carrier medium includes an external hard drive, a memory device, including a memory card, smart card, a radio frequency identification (RFID) device, USB key, magnetic card or other electronic storage device.

It will further be appreciated that any of the features in the preferred embodiments of the invention can be combined together and are not necessarily applied in isolation from each other. For example, the feature of the player being able to selectively starting or stopping spinning of the reels 12 and the feature of providing separate video screens for the lower playing area 7a and upper display area 7b can be combined into a single electronic gaming machine 1. Similar combinations of two or more features from the above described embodiments or embodiments of the invention can be readily made by one skilled in the art.

It will further be appreciated that any of the features in the preferred embodiments of the invention can be combined together and are not necessarily applied in isolation from each other. For example, the feature of a mystery jackpot can be readily combined with the feature of different array formats for each game 8.

By providing options for sets of jackpots, the invention allows players to customise the game being played on the electronic gaming machine. In addition, the availability of the jackpot sets and jackpots depends on the bet made by the player. Hence, there is a “risk vs reward” that the player needs to consider when making his or her bet in order to access a desired jackpot or jackpot set. This increases player interest and encourages the player to continue playing the various games on the same electronic gaming machine. All these advantages of the invention result in the player being more likely to retain interest in continuing to play the same electronic gaming machine. Furthermore, since the electronic game controller controls operation of the electronic gaming machine, the invention can be readily implemented to existing gaming machines and other gaming systems. In all these respects, the invention represents a practical and commercially significant improvement over the prior art.

Although the invention has been described with reference to specific examples, it will be appreciated by those skilled in the art that the invention may be embodied in many other forms.

1. An electronic gaming machine, comprising:
a display for displaying a game, wherein said game comprises game symbols and where predetermined winning combinations of randomly selected game symbols award prizes to a player;
an electronic game controller for controlling the display of said game symbols on said display; and
a value transfer mechanism for paying said prizes to said player using value in an amount equal to an awarded prize and for receiving value from said player to make a bet to play said game;
wherein said electronic game controller causes said electronic gaming machine to offer a plurality of bonus prize sets, each bonus prize set comprising at least one progressive jackpot prize, and some of said bonus prize sets are available for selection by said player depending on a designated player selection;
said player making said designated player selection, said available bonus prize sets becoming selectable by a player in a play of said game;
said player selects one of said available bonus prize sets, said selected available bonus prize set becoming active for one or more subsequent plays of said game, and one or more of said bonus prizes of said selected bonus prize set are awarded to the player upon the occurrence of a bonus prize trigger event in said one or more subsequent plays; and
said player is able to change said selected bonus prize set in said one or more subsequent plays.

2. The electronic gaming machine of claim 1, wherein said player directly selects at least one bonus prize set that is active during play of said game.

3. The electronic gaming machine of claim 1, wherein said player indirectly selects at least one bonus prize set that is active during play of said game.

4. The electronic gaming machine of claim 1, wherein at least one available bonus prize set cannot be active during said one or more subsequent plays.

5. The electronic gaming machine of claim 1, wherein said player can select all of said available bonus prize sets to be active for said one or more subsequent plays.

6. The electronic gaming machine of claim 1, wherein said player can select only one of said available bonus prize sets to be active for said one or more subsequent plays.

7. The electronic gaming machine of claim 1, wherein at least one bonus prize set comprises a mystery jackpot level which is associated with at least one of a start value, increment value and threshold ‘win before’ value,

8. The electronic gaming machine of claim 1, wherein at least one bonus prize set comprises a standalone progressive jackpot.

9. The electronic gaming machine of claim 1, wherein at least one bonus prize set comprises a linked progressive jackpot associated with a linked jackpot controller.

10. The electronic gaming machine of claim 1, wherein at least one bonus prize set comprises a symbol driven jackpot associated with a trigger combination of game symbols appearing in said game.

11. The electronic gaming machine of claim 1, wherein at least one bonus prize set comprises a standalone progressive jackpot and another bonus prize set comprises a linked progressive jackpot associated with a linked jackpot controller.

12. The electronic gaming machine of claim 1, wherein said electronic game controller causes said display to display a selection screen that can be activated at any time between plays of said game, said selection screen enabling said player to select selects one of said available bonus prize sets.

13. The electronic gaming machine of claim 12, wherein said selection screen provides a plurality of bonus prize set configuration options selectable by said player.

14. The electronic gaming machine of claim 12, wherein said selection screen enables said player to select the bet denomination for said game.

15. The electronic gaming machine of claim 14, wherein any jackpot level can be multiplied by a factor associated with the bet denomination selected by said player.

16. The electronic gaming machine of claim 12, wherein said selection screen enables said player to select the number of lines for said game.

17. The electronic gaming machine of claim 12, wherein there is a plurality of games offered by said electronic gaming machines, and said selection screen enables said player to select one or more of said games to play on said electronic gaming machine.

18. The electronic gaming machine of claim 12, wherein said electronic game controller causes said display to show a selection screen image associated with a selection screen, wherein said selection screen image is selectable by said player for accessing said selection screen.

19. The electronic gaming machine of claim 1, wherein said electronic game controller causes said electronic gaming machine to display two or more game images respectively associated with two or more of said games, wherein said game images are selectable by a player for selecting one of said games;
said electronic game controller causes said electronic gaming machine to display two or more denomination images associated with two or more of said games, wherein said denomination images are selectable by a player for selecting the bet denomination in which said selected game is to be played, and
wherein one of said game images and said denomination images is initially displayed on said display for selection by said player and is replaced by the other of said game images and said denomination images on said display after said player makes a selection of said one of said game images and said denomination images.

20. The electronic gaming machine of claim 19, wherein any jackpot level can be multiplied by a factor associate with the bet denomination selected by said player.

21. The electronic gaming machine of claim 19, wherein said electronic game controller causes said electronic gaming machine to display two or more line images associated with said selected game, wherein said line images are selectable by a player for selecting the number of lines to play in said selected game.

22. The electronic gaming machine of claim 1, wherein when said selected available bonus prize set becomes active, only the bonus prizes in said selected available jackpot set are contributed to by the electronic game controller.

23. The electronic gaming machine of claim 1, wherein any jackpot level can be changed in association with any player selection.

24. The electronic gaming machine of claim 1, wherein said electronic game controller causes said electronic gaming machine to offer one or more player versus player type games and enabling said player to select one or more of said player versus player type games, and wherein at least one of said player versus player type games comprises the award of an additional bonus prize in addition to said bonus prizes in said selected available bonus prize set.
